(19) United States
(12) Patent Application Publication
(10) Pub. No.: US 2024/0384635 A1
(43) Pub. Date: Nov. 21, 2024

(54) HIGH CONCENTRATION CHEMICAL FIELD METERING SYSTEM

(71) Applicant: SOLVAY USA INC., Princeton, NJ (US)

(72) Inventors: Dru Bishop, The Woodlands, TX (US); John Pokorny, The Woodlands, TX (US); Robert James Fullerton, Shreveport, LA (US)

(73) Assignee: ENERGY SOLUTIONS (US) LLC, Princeton, NJ (US)

(21) Appl. No.: 18/557,898

(22) PCT Filed: Jun. 24, 2022
(86) PCT No.: PCT/US2022/034994

§ 371 Date: Oct. 27, 2023

Related U.S. Application Data
(60) Provisional application No. 63/313,554, filed on Feb. 24, 2022.
(60) Provisional application No. 63/215,301, filed on Jun. 25, 2021.

(51) Int. Cl. E21B 43/26; E21B 43/12

(52) U.S. Cl. CPC E21B 43/2607; E21B 43/12; B01F 2101/49

(57) ABSTRACT

A method includes providing a movable module to a worksite, the movable module including a pump, a variable frequency drive coupled to the pump, a programmable logic controller operatively coupled to the variable frequency drive, and a first flow meter coupled to an outlet of the pump. The method also includes coupling a tank to a suction end of the pump, the tank having a concentrated chemical disposed therein, and coupling an outlet of the pump to a blender fluid flowline. The method also includes providing a low dosage of the concentrated chemical of between 0.01 and 0.15 gallons per thousand gallons to a clean fluid in the blender fluid flowline by pumping the concentrated chemical with the pump from the tank to the blender fluid flowline and adjusting an amount of the concentrated chemical pumped in response to data input into the programmable logic controller.

### BACKGROUND

The flow of hydrocarbons from a reservoir into a well bore may be improved to increase production of a well by various well interventions including well stimulation. Common well stimulation methods include acid injection, manual stimulation with explosives, and hydraulic fracturing. Hydraulic fracturing is commonly used in low permeability wells and includes pumping specially formulated fluids downhole at high pressures to force open fissures in the subterranean rock. The specially formulated fluids used for hydraulic fracturing may include various liquids, chemicals, and/or materials, each of which are included for various specific purposes. For example, the specially formulated fluids may include biocides, surfactants, scale inhibitors, friction reducers, clay stabilizers, proppants, corrosion inhibitors, crosslinkers, and/or pH adjusting agents, among others additives. The chemicals or additives used today in formulating the fluids for hydraulic fracturing process are generally diluted to lower the perceived cost to the end user (cost/gal).

### SUMMARY

In one aspect, embodiments disclosed herein relate to a method including providing a movable module to a worksite, the movable module including a pump, a variable frequency drive coupled to the pump, a programmable logic controller operatively coupled to the variable frequency drive, and a first flow meter coupled to an outlet of the pump; coupling a tank to a suction end of the pump, the tank having a concentrated chemical disposed therein; coupling an outlet of the pump to a blender fluid flowline, the blender fluid flowline positioned external to the movable module; and providing a low dosage of the concentrated chemical of between 0.01 and 0.15 gallons per thousand gallons (GPT) to a clean fluid in the blender fluid flowline by pumping the concentrated chemical with the pump from the tank to the blender fluid flowline and adjusting an amount of the concentrated chemical pumped in response to data input into the programmable logic controller.

In another aspect, embodiments disclosed herein relate to a method including providing a movable base with a pump, a motor coupled to the pump, a variable drive coupled to the motor, a programmable logic controller coupled to the variable drive, an inlet flowline coupled to a suction end of the pump, an outlet flowline coupled to a discharge of the pump, and a first flow meter coupled to the outlet flowline; positioning the movable base at a worksite, coupling the inlet flowline to a tank, the tank having a concentrated chemical disposed therein, and coupling the outlet flowline to a blender fluid flowline at the worksite, the blender fluid flowline providing a flow of a clean fluid; and pumping a dosage of concentrated chemical of between 0.01 and 0.15 gallons per thousand gallons (GPT) to the clean fluid in the blender fluid flowline.

In another aspect, embodiments disclosed herein relate to a method including providing a movable base with a high concentration dosing system, positioning the movable base at a worksite, coupling a flowline between the high concentration dosing system and a blender fluid flowline at the worksite, the blender fluid flowline providing a flow of a clean fluid, and providing a dosage of concentrated chemical of between 0.01 and 0.15 gallons per thousand gallons (GPT) to the clean fluid in the blender fluid flowline.

In another aspect, embodiments disclosed herein relate to a system including a pump; a variable drive coupled to the pump; a flow meter coupled to an outlet of the pump; a programmable logic controller operatively coupled to the flow meter and operatively coupled to the variable drive; a base, wherein the pump, the variable drive, the flow meter, and programmable logic controller are coupled to the base; and an inlet flowline coupled to a suction end of the pump and an outlet flowline coupled to a discharge end of the pump, wherein the programmable logic controller is configured to receive data from the flow meter representative of a flow rate of a concentrated chemical discharged by the pump and to send a signal to the variable drive to control the pump based on the data representative of a flow rate of the concentrated chemical to provide a dosage of concentrated chemical of between 0.01 and 0.15 gallons per thousand gallons (GPT) to a clean fluid.

Other aspects and advantages of the invention will be apparent from the following description and the appended claims.

### BRIEF DESCRIPTION OF DRAWINGS

The following is a description of the figures in the accompanying drawings. In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn are not necessarily intended to convey any information regarding the actual shape of the particular elements and have been solely selected for ease of recognition in the drawing.

FIG. 1 is a schematic of field delivery system in accordance with embodiments of the present application.

FIG. 2 is a schematic for an electrical for a field delivery system in accordance with embodiments of the present application.

FIG. 3 is a schematic of a field delivery system in accordance with embodiments of the present application.

FIG. 4 is a front perspective view of a field delivery system in accordance with embodiments of the present application.

FIG. 5 is a side perspective view of a field delivery system in accordance with embodiments of the present application.

FIG. 6 is a method for delivery a concentrated chemical at a low dosage rate in accordance with embodiments of the present application.

FIG. 7 is a method for delivery a concentrated chemical at a low dosage rate in accordance with embodiments of the present application.

FIG. 8 is a table of data showing an example of the chemical loading, the job clean rate, and the resultant chemical rate for a field delivery system in accordance with embodiments of the present application.

FIG. 9 is a schematic of field delivery system in accordance with embodiments of the present application.

FIG. 10 is a schematic of field delivery system in accordance with embodiments of the present application.

FIG. 11 is a schematic of field delivery system in accordance with embodiments of the present application.

### DETAILED DESCRIPTION

In the following detailed description, certain specific details are set forth in order to provide a thorough understanding of various disclosed implementations and embodiments. However, one skilled in the relevant art will recognize that implementations and embodiments may be practiced without one or more of these specific details, or with other methods, components, materials, and so forth. For the sake of continuity, and in the interest of conciseness, same or similar reference characters may be used for same or similar objects in multiple figures.

Embodiments disclosed herein are directed to a compact, easily deployable field delivery system of high concentration additives designed to deliver accurate extremely low dosage rates based on a clean water pump rate. In one or more embodiments, the field delivery system provides a dosing flow rate of the high concentrated chemicals that is adjusted automatically in proportion to changes in the clean water flow rate to maintain a desired concentration.

Embodiments disclosed herein may provide a field delivery system that is easily movable or transportable to a worksite, the field delivery system configured to provide chemicals to a fluid used in, for example, stimulation of an oilfield well. For example, the field delivery system may be designed to deliver accurate extremely low dosage rates of various types of frac additives based on a clean fluid pump rate. As used herein, frac additives are chemicals or substances used in hydraulic fracturing fluids that are pumped downhole into subterranean rock formations. Frac additives may include one or more of biocides, surfactants, scale inhibitors, friction reducers, and clay stabilizers. As used herein, a clean fluid refers to a fluid to which an additive, chemical, substance, or other material will be added. In other words, the clean fluid is a base fluid without the additive. For example, the additive, chemical, substance, or other material may be added to the clean fluid prior to or as the fluid is pumped downhole. In one or more embodiments, the clean fluid may be water. However, other fluids, including fluids that are not devoid of other liquids, fluids, substances, chemicals, etc., may also be considered a clean fluid. A dosing flow rate of the concentrated chemicals (e.g., frac additives) are added to the clean fluid by pumping the concentrated chemicals into the blender fluid flowline. The dosing flow rate of the concentrated chemicals may be adjusted automatically in proportion to changes in the clean water flow rate to maintain the desired concentration for performing the hydraulic fracturing process.

The field delivery system is designed such that the field delivery system may be coupled to existing fracturing equipment on a wellsite (e.g., a “plug and play” system) to allow for high concentrated chemicals to be dosed into the clean water flowline and achieve the desired concentration for hydraulic fracturing. Traditionally, chemicals or additives used for hydraulic fracturing process are diluted and transported to the wellsite in dilute form in multiple bulk trucks to transfer the liquid chemicals. For example, traditionally, chemicals that may have an activity of 60% are diluted down to about 15% at a facility before delivery to the wellsite or before introduction into a delivery system. Higher concentration additives have been rejected in the past due to the inability of pressure pumpers to dose these (high cost/gal) concentrates at the extremely low rates required with any existing fracturing equipment.

The field delivery system according to embodiments disclosed herein is designed to automatically provide and/or adjust the low dosage of concentrated chemicals into a clean water flowline to achieve and maintain a desired concentration for a hydraulic fracture injection fluid. More specifically, the concentrated chemicals are “high” concentration frac additives (e.g., biocides, surfactants, scale inhibitors, clay stabilizers, etc.) and thus a low dosage of the chemical into the clean water flowline is needed to achieve the desired makeup of the hydraulic fracture injection fluid. As used herein, “concentrated chemicals” refer to “high” concentrated chemicals which have an activity of 25% or higher. For example, the chemicals used in the field delivery system disclosed herein may include biocides with activities of greater than 20%, including, for example, 25%, 30%, 40%, 50%, 75% or greater, scale inhibitors with activities of greater than 20%, including 25%, 30%, 40%, 50% or greater, and surfactants with activities of greater than 20%, including 25%, 30%, 40%, 60% or greater. In contrast, conventional chemicals for hydraulic fracturing operations are provided at a field strength concentration of 20% or less. For example, conventional chemicals for hydraulic fracturing operation may include a biocide with an activity of 20%, 5%, or less, a scale inhibitor with an activity of 12%, 5%, or less, and a surfactant with an activity of 10%, 4%, or less. Thus, conventional systems (using diluted chemicals/additives) generally dose chemicals or additives with a loading of 0.15-2.0 GPT (gallon per 1,000 gallon) (0.15-2.0 l/m³) of clean water. In contrast, the field delivery system in accordance with embodiments disclosed herein provides concentrated chemicals at a loading of 0.010 to 0.15 GPT (0.010 to 0.15 l/m³).

The field delivery system and method advantageously allow for concentrated chemicals to be transported to a wellsite which provides a significant reduction in the volumetric storage requirements of the needed chemicals, logistical costs and traffic, and subsequent footprint of storage systems on a well pad. Instead of using multiple bulk trucks to transfer the liquid chemicals, a few smaller or intermediate tanks, such as totes, of the concentrated chemicals can be delivered and the contemplated system can be used to dose the appropriate low amount into the clean water flow line.

A field delivery system and method designed in accordance with the present application may also allow for delivery of a chemical to a fluid in, for example, a clean water flowline, that includes transporting a concentrated chemical to a worksite and providing reliable dosing of the concentrated chemical at a desired low rate even during start up and stoppage of the delivery of the chemical to the fluid. For example, conventional systems often observe spikes in dosage of chemicals when a delivery system is started or stopped due to, for example, starting or stopping of a pump that is pumping a diluted chemical. In contrast, embodiments described herein may provide a more constant or consistent dosing of chemical, without the dosing spikes seen in conventional systems, as the chemical is metered into the fluid.

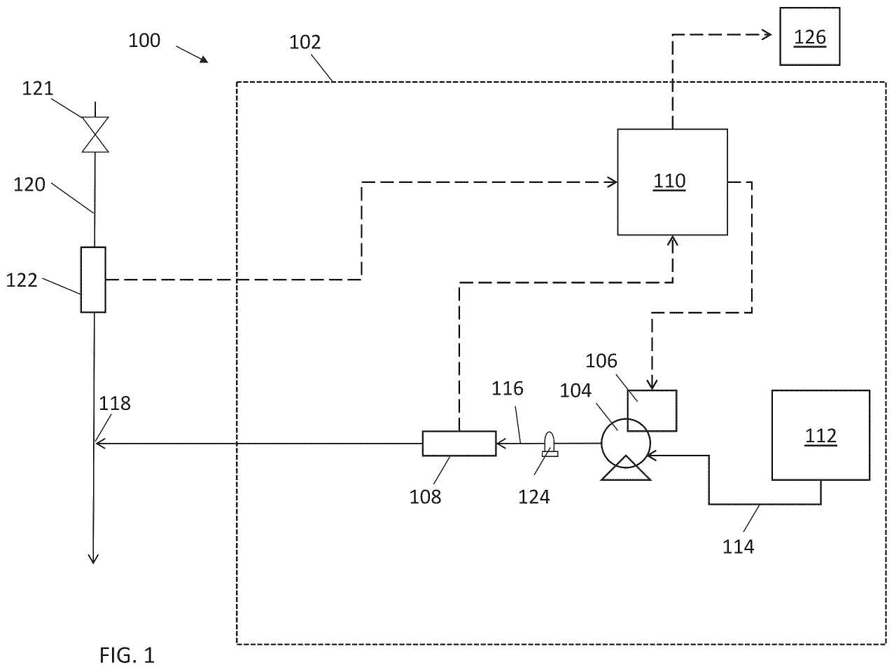

Referring now to FIG. 1, a schematic of field delivery system 100 in accordance with embodiments of the present application is shown. The field delivery system 100 is provided in a module 102 or on a pallet (not shown) so that the system is compact and easily transported, for example on the back of a small trailer, to a well site and may be movable via, for example, forklift or pallet jack. The field delivery system 100 includes a pump 104, a variable frequency drive 106, a flow meter 108 (also referred to herein as a chemical flow meter 108), and a programmable logic controller (PLC) 110.

A tote 112 for containing a volume of concentrated chemical (i.e., a frac additive) is connected to a suction end of the pump 104 via inlet flowline 114. A tote generally refers to an intermediate bulk container for the transport of bulk liquids ranging in volumes between, generally, 250 and 350 gallons. The tote may be formed from high-density polyethylene (HDPE) or other materials suitable for holding concentrated frac additives. The tote may be positioned in the module 102 or pallet or may be positioned next to the module 102 or pallet. A first end of the inlet flowline 114 may be coupled to a valve or tap (not shown) on the tote 112 and a second end of the inlet flowline 114 may be coupled to the suction end of the pump 104.

In one or more embodiments, the pump 104 is a positive displacement pump. For example, the pump 104 may be a metering pump that is configured to provide a specific adjustable volumetric flowrate of a liquid, i.e., the concentrated chemical in the tote 112. More specifically, in one or more embodiments, pump 104 may be a hydraulically driven diaphragm pump, a gear pump, or a peristaltic hose pump.

The pump 104 includes a motor (not shown) which is controlled by a variable drive, such as the variable frequency drive 106 or variable speed drive. The variable frequency drive 106 is operatively connected to the PLC 110 and automatically controls the flow rate of the concentrated chemical through the pump 104 by changing the pump stroke speed of the pump 104. The pump 104 may include a calibrated dial for adjusting the capacity of the pump between, for example, 10% to 100%.

An outlet flowline 116 is coupled to an outlet or discharge of the pump 104 and to an injection port or inlet 118 of a blender fluid flowline 120. The blender fluid flowline 120 may be a flowline external to the field delivery system 100 and therefore not housed within or on the module 102. A clean fluid is flowed through the blender fluid flowline 120 and includes one or more injection ports/inlets 118 through which one or more additives/chemicals are added to the clean fluid to form a blended fluid. The blender fluid flowline 120 may be a flowline that is coupled to an injection pump (not shown) for injecting the blended fluid (i.e., a combination of the clean fluid and one or more additives such as frac additives, including the concentrated chemical from tote 112) into a formation for hydraulic fracturing of the formation rock.

The flow meter 108 may be disposed in the outlet flowline 116 and configured to measure the rate of flow of the concentrated chemical between the pump 104 of the field delivery system 100 and the blender fluid flowline 120. In some embodiments, the flow meter 108 may be a turbine flow meter. In other embodiments, the flow meter 108 may be a Coriolis flow meter. The flow meter 108 may be operatively coupled to the PLC 110 and may transmit data representative of the flow rate of concentrated chemical in outlet flowline 116 to the PLC 110. The flow meter 108 may thus provide flow rate validation of the concentrated chemical exiting the pump 104 to ensure that a proper dosing of the concentrated chemical is supplied to the blender fluid flowline 120.

The blender fluid flowline 120 also includes a flow meter 122 (also referred to herein as a blender flow meter 122) positioned upstream of the injection port or inlet 118 of the blender fluid flowline 120. Thus, the flow meter 122 is configured to measure the rate of flow of the clean fluid prior to the addition of the concentrated chemical from the field delivery system 100. The flow meter 122 may be, for example, a turbine flow meter or a Coriolis flow meter. The flow meter 122 of the blender fluid flowline 120 is operatively coupled to the PLC 110 of the field delivery system 100 and transmits data representative of the flow rate of the clean fluid in the blender fluid flowline 120 to the PLC 110. The PLC 110 may thus compare a first input (the flow rate of the concentrated chemical in outlet flowline 116) and a second input (the flow rate of the clean fluid in the blender fluid flowline 120 upstream of the injection port or inlet 118) to validate the desired dosing of concentrated chemical to achieve a desired concentration in the blender fluid flowline 120.

In accordance with embodiments disclosed herein, the PLC 110 is configured to automatically adjust the pump speed, through the PLC's coupling with the variable frequency drive 106, and therefore adjust the dosing of concentrated chemical into the blender fluid flowline 120, in response to variations or changes in the flow rate of the clean fluid flowing through the blender fluid flowline 120, as measured by the flow meter 122. Further, PLC 110 may additionally or alternatively control a valve 121 in the blender fluid flowline 120 to adjust a flow rate of the clean fluid to ensure a desired and accurate dosing of the concentrated chemical is achieved. For example, the field delivery system 100 in accordance with embodiments disclosed herein provides concentrated chemicals (e.g., chemicals with activities of greater than 20%) at a loading of 0.010 to 0.15 GPT (0.010 to 0.15 l/m³) to the clean fluid in the blender fluid flowline 120.

In one or more embodiments, the field delivery system 100 may optionally include a pressure dampener 124 coupled to the outlet flowline 116 between the outlet of pump 104 and the flow meter 108. The pressure dampener 124 is configured to dampen any pulsations of flow and maintain continuous flow through the flow meter 108 to protect and ensure accurate flow measurements by flow meter 108.

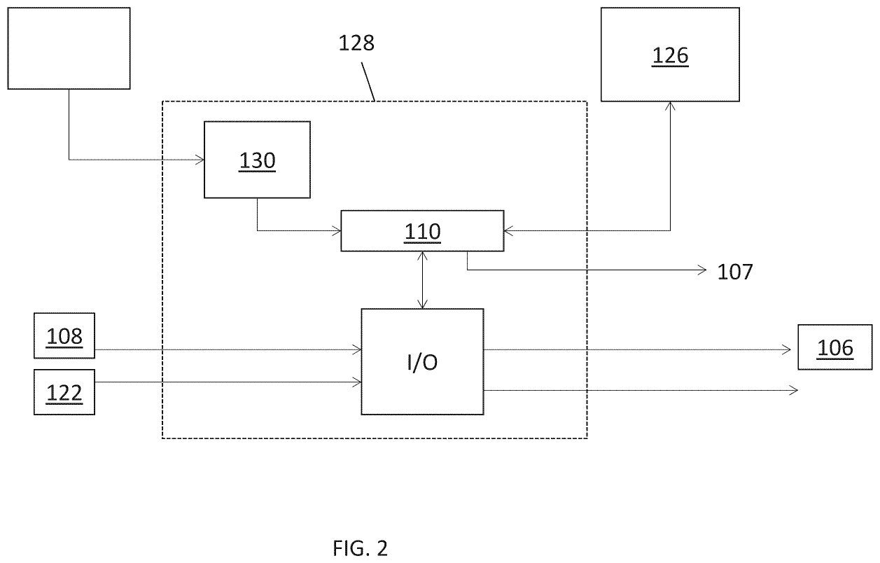

The field delivery system 100 may also include a human machine interface (HMI) 126, for example, a computer, tablet, monitor, etc. that allows the user to input data into and receive data from the PLC 110. For example, as shown in FIG. 2, field delivery system (100, FIG. 1) in accordance with one or more embodiments may include an electrical box 128 that houses the PLC 110 and its associated power supply 130. The PLC is configured to receive various inputs from, for example, flow meters (108, 122, FIG. 1) and the HMI 126, and transmit various outputs. In one or more embodiments, the HMI 126 of the field delivery system 100 allows a user to input to the PLC 110 a set range of desired volumetric flow rates of the concentrated chemicals, concentrations of the concentrated chemicals, and/or ranges of desired concentrations of a blended flow of the concentrated chemicals combined with the clean fluid, and to receive data representative of, for example, the volumetric flow rate of concentrated chemicals in outlet flowline 116 and the volumetric flow rate of the clean fluid in blender fluid flowline 120. The PLC 110 may be coupled to one or more communication services such as a value-added network (VAN) or ethernet datalink 107.

Referring to FIG. 1, in one or more embodiments, the field delivery system 100 may include more than one pump 104, variable frequency drive 106, and flow meter 108, and additional flowlines (114, 116) to accommodate more than one concentrated chemical. For example, two totes 112 containing the same or different concentrated chemicals may be coupled to two separate inlet flowlines 114, each inlet flowline 114 coupling each tote 112 to a separate pump 104, and each pump 104 coupled to the blender fluid flowline 120 via separate outlet flowlines 116. Each pump is coupled to the PLC 110 and configured to provide a desired dose of each concentrated chemical to the blender fluid flowline 120 through the outlet flowlines 116. Such configuration allows for two different chemicals at two same or different dosing rates to be provided to the same clean fluid in the blender fluid flowline 120 to obtain a desired makeup of a blended fluid. One of ordinary skill in the art will appreciate that two, three, or more totes of different concentrated chemicals may similarly be coupled to the field delivery system 100, and thus the field delivery system 100 may include two, three, or more pumps, variable frequency drives, PLCs, flow meters, and inlet and outlet flowlines.

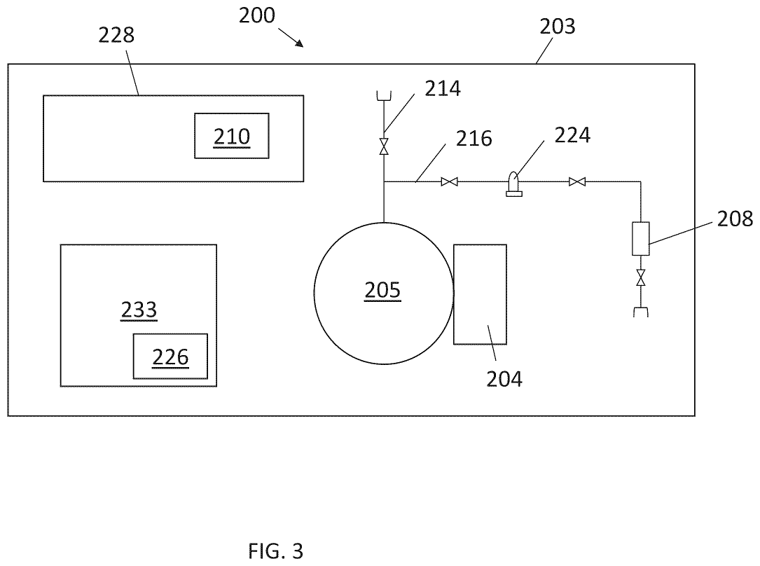

Referring to FIG. 3, in one or more embodiments, a field delivery system 200 in accordance with the present application provides a compact and/or modular system for that includes equipment for providing accurate, very low dose rates of a concentrated chemical to a blender fluid flowline (not shown) as described above. As shown in FIG. 3, the field delivery system 200 may include a base 203 on which the pump 204, motor 205 (with drive, not independently illustrated), an inlet flowline 214, an outlet flowline 216, a flow meter 208 coupled to the outlet flowline 216, and a pressure dampener 224 coupled to the outlet flowline 216 between the outlet of the pump 204 and the flow meter 208. In one or more embodiments, the inlet or suction of pump 204 is 3/4 inch in diameter and a discharge of the pump is 1/2 inch. Pump discharge is coupled to the outlet flowline 216 which is coupled to the blender fluid flowline (not shown). The base 203 also supports an electrical box 228 which includes the PLC, power supply, and associated electrical equipment. An operator workstation 233 may also be disposed on the base 203. In some embodiments, the operator workstation 233 may include a stand or structure designed to support and secure a laptop, tablet, screen, or other HMI 226. The PLC 110 may be coupled to one or more communication services such as a value-added network (VAN) or ethernet datalink. The flowlines 214, 216 may be formed from stainless steel piping.

In accordance with embodiments disclosed herein, the PLC 210 is configured to automatically adjust the pump speed, through the PLC's coupling with the motor 205, e.g. with a variable frequency drive or variable speed drive, and therefore adjust the dosing of concentrated chemical into the blender fluid flowline (not shown), in response to variations or changes in the flow rate of the clean fluid flowing through the blender fluid flowline (not shown), as measured by the flow meter (not shown) in the blender fluid flowline (not shown) operatively coupled to the pump 204. Further, PLC 210 may additionally or alternatively control a valve (not shown) in the blender fluid flowline (not shown) to adjust a flow rate of the clean fluid to ensure a desired and accurate dosing of the concentrated chemical is achieved. For example, the field delivery system 200 in accordance with embodiments disclosed herein provides concentrated chemicals (e.g., chemicals with activities of greater than 20%) at a loading of 0.010 to 0.15 GPT (0.010 to 0.15 l/m³) to the clean fluid in the blender fluid flowline (not shown).

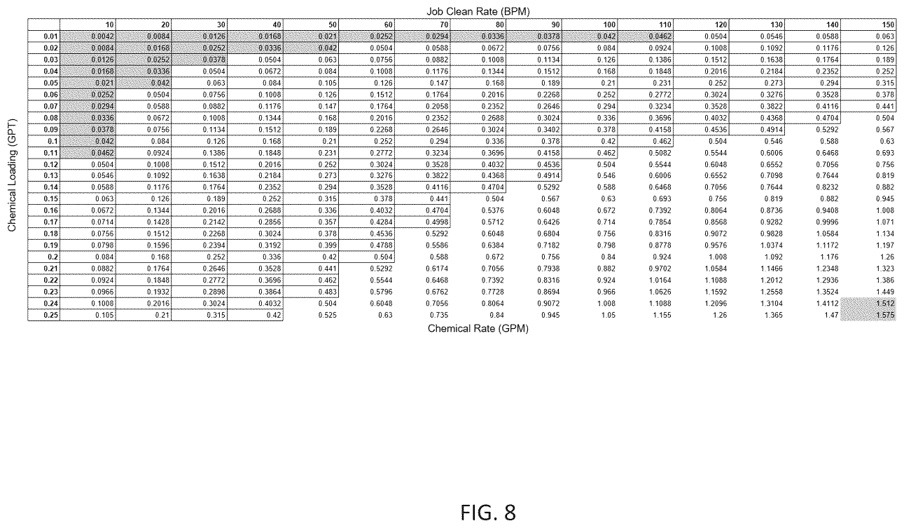

FIG. 8 is a table that shows an example of the chemical loading (in GPT), the job clean rate (in barrels-per-minute (BPM)), and the resultant chemical rate (in gallons-per-minute (GPM)) for a field delivery system as described in the present application. Embodiments disclosed herein provide a field delivery system and method that may provide a concentrated chemical to fluid, e.g., a frac fluid, at chemical rate in a range of approximately 0.05 to 1.5 GPM, as shown as the non-grayed areas of the table in FIG. 8. For example, with a chemical loading of 0.09 and a job clean rate of 60 BPM, a field delivery system in accordance with embodiments disclosed herein provides a resulting chemical rate of 0.2268 GPM. In contrast, conventional equipment cannot provide chemical rates below 0.5 GPM (as indicated by the area shown in FIG. 8 that is not lined). As shown in FIG. 8, a field delivery system in accordance with the present application may be capable of pumping a concentrated chemical into a clean water flowline at a range of rates, ranging from, for example, 10 BPM to 150 BPM or greater, with a chemical loading rate ranging from, for example, 0.01 GPT to 0.25 GPT or greater, to provide a chemical rate ranging from 0.05 to 1.5 GPM or greater. Accordingly, a field delivery system as described herein provides an operator with flexibility in chemicals and chemical concentrations being used while maintaining control of the desired chemical rate introduced into a well.

Table 1 below shows an example of a chemical, labeled Product X, having an activity of 5% as is common with traditional diluted chemicals. The job clean rate is 100 BPM with a chemical loading of 0.25 GPT and a chemical rate of 1.05 GPM. The example well has a job barrel count of 10,000 barrels and 250 total stages, or intervals of a well. As shown the total chemical volume in this example is 26,250 gallons, which would fill 84 totes (each tote having a working volume of 315 gallons), or 6 ISO tanks (each ISO tank having a working volume of 4,500 gallons).

TABLE 1
Example Chemical Product with Low Activity

| Product X | 5.00% | Activity |
|---|---|---|
| Loading | 0.25 | GPT |
| Job Rate | 100 | BPM |
| Chemical Rate | 1.05 | GPM |
| Job Bbl Count | 10,000 | Bbls |
| Total Stages | 250 | Stages |
| Total Chemical Volume | 26,250 | Gal |
| # of Totes | 84 | Totes |
| # of ISO tanks | 6 | ISO tanks |

By comparison, Table 2 below shows an example of a concentrated chemical, labeled Product Y, having an activity of 50% that may be pumped into a clean water line using a field delivery system in accordance with embodiments disclosed herein that is loaded at 0.03 GPT into flow line with a job rate of 100 BPM, providing a chemical rate of 0.105 GPM. Product Y is also added to a job having a 10,000 job barrel count and 250 stages. However, the total chemical volume needed is only 2,625 gallons (a reduction in volume of approximately 90%), which would fill only 9 totes or less than 1 ISO tank.

TABLE 2
Example Chemical Product with Low Activity

| Product Y | 50.00% | Activity |
|---|---|---|
| Loading | 0.03 | GPT |
| Job Rate | 100 | BPM |
| Chemical Rate | 0.105 | GPM |
| Job Bbl Count | 10,000 | Bbls |
| Total Stages | 250 | Stages |
| Total Chemical Volume | 2,625 | Gal |
| # of Totes | 9 | Totes |
| # of ISO tanks | <1 | ISO tanks |

Referring back to FIG. 3, in one or more embodiments, the field delivery system 200 may include more than one pump 104, variable frequency drive 106, and flow meter 108, and additional flowlines (114, 116) to accommodate more than one concentrated chemical. For example, two totes (not shown) containing the same or different concentrated chemicals may be coupled to two separate inlet flowlines 214, each inlet flowline 214 coupling each tote to a separate pump 204, and each pump 204 coupled to the blender fluid flowline (not shown) via separate outlet flowlines 216. Each pump is coupled to the PLC 210 and configured to provide a desired dose of each concentrated chemical to the blender fluid flowline (not shown) through the outlet flowlines 216. Such configuration allows for two different chemicals at two same or different dosing rates to be provided to the same clean fluid in the blender fluid flowline (not shown) to obtain a desired makeup of a blended fluid. One of ordinary skill in the art will appreciate that two, three, or more totes of different concentrated chemicals may similarly be coupled to the field delivery system 200, and thus the field delivery system 200 may include two, three, or more pumps, variable frequency drives, PLCs, flow meters, and inlet and outlet flowlines.

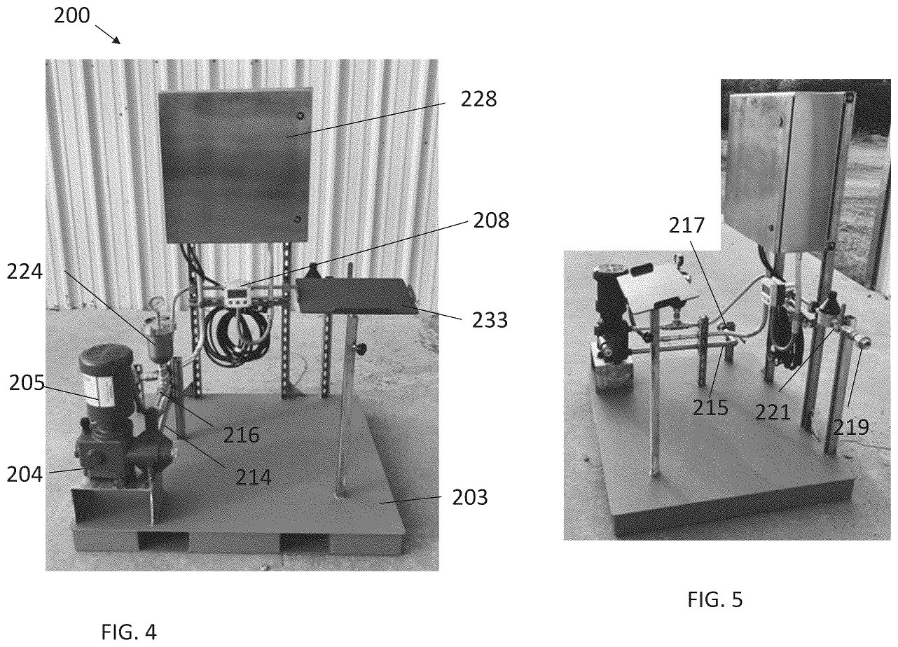

FIGS. 4 and 5 shows a front perspective view and a side perspective view, respectively, of an example of the field delivery system 200 shown in FIG. 3 in accordance with embodiments disclosed herein. As shown in FIGS. 4 and 5, the field delivery system 200 includes a base 203 on which a pump 204, an operator workstation 233, and an electrical box 228 are mounted. An inlet flowline 214 is connected to an inlet or suction of pump 204 at one end and at a second end 215 includes a valve 217, the second end 215 configured to be coupled to a tank, such as a tote (not shown) containing a concentrated chemical. An outlet flowline 216 is coupled to outlet of the pump 204 at a first end and at a second end 219 includes a valve 221, the second end 219 of the outlet flowline 216 be configured to connect to a blender fluid flowline (not shown). A flow meter 208 is coupled to the outlet flowline 216 between the pump 204 and the second end 219 of the outlet flowline 216. Additionally, a pressure dampener 224 is coupled to the outlet flowline 216 between the pump 204 and the second end 219 of the outlet flowline 216. The pump 204 includes a motor 205 (with variable drive, not independently illustrated. The inlet or suction of pump 204 may be ¾ inch in diameter and a discharge of the pump is ½ inch.

The electrical box 228 houses a PLC (not shown), a power supply (not shown), and associated electrical equipment (not shown). An operator workstation 233 may also be disposed on the base 203. In some embodiments, the operator workstation 233 may include a stand or structure designed to support and secure a laptop, tablet, screen, or other HMI 226. The PLC 110 may be coupled to one or more communication services such as a value-added network (VAN) or ethernet datalink. The flowlines 214, 216 may be formed from stainless steel piping.

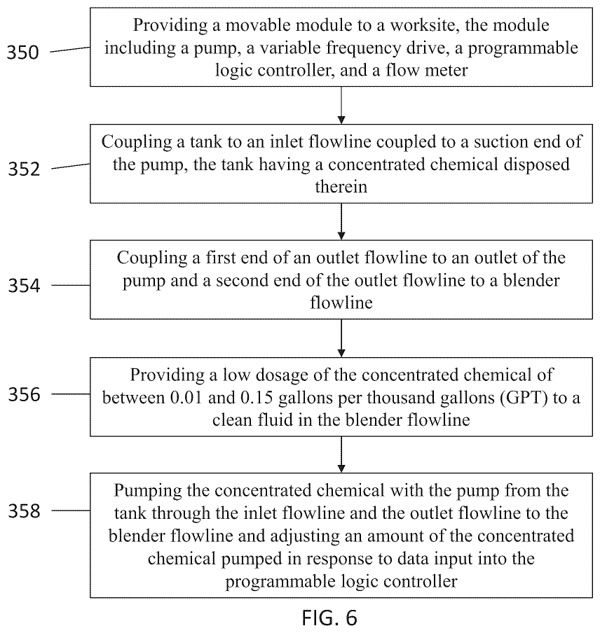

Referring now to FIG. 6, a method in accordance with embodiments of the present application is described. In one or more embodiments, the method includes providing a movable module to a worksite (shown at 350). As described above with respect to FIGS. 1-5, the movable module may include a pump, a variable frequency drive coupled to the pump, a programmable logic controller operatively coupled to the variable frequency drive, and a first flow meter coupled to an outlet of the pump. The method further includes coupling a tank to an inlet flowline coupled to a suction end of the pump (shown at 352), the tank having a concentrated chemical disposed therein. The inlet flow line may be coupled to a valve of the tote. As discussed above, the concentrated chemical may be a frac additives, including, for example, one or more biocide, surfactant, scale inhibitor, friction reducer, or clay stabilizer. The concentrated chemical has an activity of 25% or higher.

The method further includes coupling a first end of an outlet flowline to an outlet of the pump and a second end of the outlet flowline to a blender fluid flowline (shown at 354). The blender fluid flowline may be positioned external to the module and may be an existing flowline at the worksite. Accordingly, the module may be positioned at the worksite in a location such that the second end of the outlet flowline may be connected to an inlet or coupling of a blender fluid flowline. Once the moveable module is positioned in the worksite and coupled to the tank of a concentrated chemical and the blender fluid flowline, the method in accordance with the present disclosure includes providing a low dosage of the concentrated chemical of between 0.01 and 0.15 gallons per thousand gallons (GPT) to a clean fluid in the blender fluid flowline (shown at 356) by pumping the concentrated chemical with the pump from the tank through the inlet flowline and the outlet flowline to the blender fluid flowline and adjusting an amount of the concentrated chemical pumped in response to data input into the programmable logic controller (shown at 358).

In one or more embodiments, the adjusting an amount of the concentrated chemical (358) includes controlling a flow rate of the concentrated chemical entering the blender fluid flowline. The flow rate of the concentrated chemical entering the blender fluid flowline may be controlled by determining a flow rate of the concentrated chemical in the outlet flowline with the flow meter, providing the flow rate as an input to the PLC, and providing a signal from the PLC to the variable frequency drive. The signal from the PLC to the variable frequency drive may adjust, for example, a frequency and a voltage input to a motor coupled to the pump based on the flow rate of the concentrated chemical. For example, if the flow rate of the concentrated chemical is lower than necessary to obtain a desired blended fluid, the PLC may signal the variable frequency drive to increase the flow rate through the pump of the concentrated chemical. Similarly, if the flow rate of the concentrated chemical is higher than necessary to obtain the desired blended fluid, the PLC may signal the variable frequency drive to decrease the flow rate through the pump of the concentrated chemical.

Providing a low dosage of concentrated chemical of the method disclosed herein may further include determining a flow rate of a clean fluid in the blender fluid flowline with a second flow meter coupled to the blender fluid flowline upstream of a coupling of the first end of the outlet flow to the blender fluid flowline, providing the flow rate as an input to the programmable logic controller, and providing a signal from the programmable logic controller to the variable frequency drive to adjust a motor coupled to the pump based on the flow rate of the concentrated chemical and the flow rate of the clean fluid. For example, the second flow meter measures the flow rate of clean fluid through the blender fluid flowline and sends the measured flow rates to the PLC as inputs. If the flow rate of the clean fluid increases or decreases, the PLC sends a signal to the variable flow device to adjust the flow rate of the concentrated chemical through the outlet flowline so that a desired mixture of the bended fluid may be maintained. Alternatively, or in addition, a user may adjust the flow rate of the concentrated chemical by entering an input to the PLC via a human machine interface, such as a screen, computer, tablet, etc.

Additional concentrated chemicals may need to be added to the clean fluid to obtain the desired mixture of the blended fluid. Thus, in accordance with one or more embodiments, the method may further include providing the movable module with a second pump, a second variable frequency drive coupled to the second pump, the second variable frequency drive coupled to the programmable logic controller, and a third flow meter coupled to an outlet of the second pump. A second tank may be coupled to a second inlet flowline coupled to a suction end of the second pump, the second tank having a second concentrated chemical disposed therein. A first end of a second outlet flowline may be coupled to an outlet of the second pump and a second end of the second outlet flowline to the blender fluid flowline. In accordance with this method, a low dosage of the second concentrated chemical of between 0.01 and 0.15 gallons per thousand gallons (GPT) is then provided to the clean fluid in the blender fluid flowline by pumping the second concentrated chemical with the second pump from the second tank through the second inlet flowline and the second outlet flowline to the blender fluid flowline and adjusting an amount of the second concentrated chemical pumped in response to data input into the programmable logic controller. As discussed above, in one or more embodiments, the concentrated chemical is a frac additive, such as a biocide, surfactant, scale inhibitor, or clay stabilizer that is transported and stored in the tank (or tote) in concentrated form such that the concentrated chemical has an activity of greater than 20%. In other embodiments, the concentrated chemical has an activity greater than 30%, 40%, 50% or 60%.

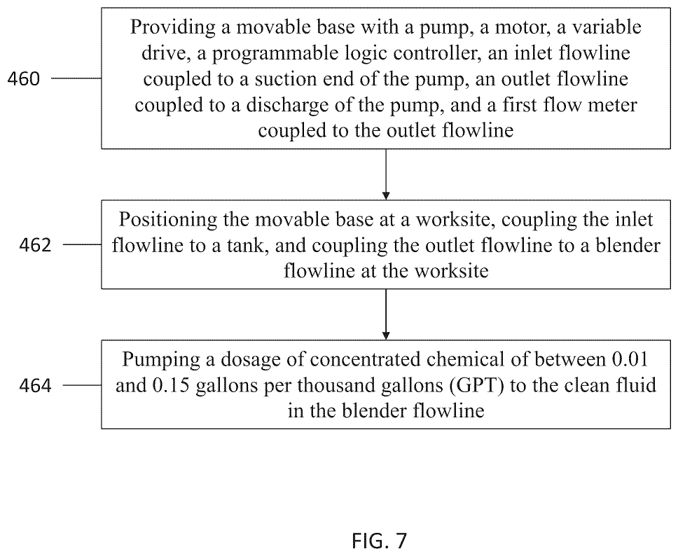

Referring to FIG. 7, a method in accordance with embodiments of the present application is described. In one or more embodiments, the method includes providing a movable base with a pump, a motor coupled to the pump, a variable drive coupled to the motor, a programmable logic controller coupled to the variable drive, an inlet flowline coupled to a suction end of the pump, an outlet flowline coupled to a discharge of the pump, and a first flow meter coupled to the outlet flowline (shown at 460). The method also includes positioning the movable base at a worksite, coupling the inlet flowline to a tank, and coupling the outlet flowline to a blender fluid flowline at the worksite (shown at 462). The blender fluid flowline provides a flow of a clean fluid, i.e., a fluid without added chemicals such as frac additives. The tank stores the concentrated chemical therein. In some embodiments, the tank may be an intermediate bulk tank such as a tote.

The method further includes pumping a dosage of concentrated chemical of between 0.01 and 0.15 gallons per thousand gallons (GPT) to the clean fluid in the blender fluid flowline (shown at 464). Thus, the movable base includes the necessary equipment to provide a concentrated chemical from a tank to the blender fluid flowline at the desired low dosage into the to mix the concentrated chemical with the clean fluid to provide a desired blended fluid to pump downhole for hydraulic fracturing of a rock formation.

In one or more embodiments, the method may further include validating the flow rate of the concentrated chemical in the outlet flowline. The validating the flow rate of the concentrated chemical in the outlet flowline includes measuring a flow rate of the concentrated chemical in the outlet flowline with the first flow meter, and providing the flow rate of the concentrated chemical as an input to the PLC. The PLC may then compare the measured flow rate with a desired flow rate input into the PLC via, for example, an HMI. If the PLC determines that the flow rate of the concentrated chemical is not equal to the desired flow rate, i.e., the flow rate is not validated, then the flow rate of the concentrated chemical may be adjusted.

The flow rate of the concentrated chemical may be adjusted by measuring a flow rate of the clean fluid in the blender fluid flowline with a second flow meter coupled to the blender fluid flowline, providing the flow rate of the clean fluid as an input to the programmable logic controller, and sending a signal from the programmable logic controller to the variable drive based on the flow rate of the concentrated chemical and the flow rate of the clean fluid to vary the frequency and voltage input to the motor to control the pump. The flow rate of the concentrated chemical may thus be adjusted by sending a signal from the PLC to the variable drive to vary a frequency and voltage input to the motor to control the pump to maintain the dosage of concentrated chemical of between 0.01 and 0.15 gallons per thousand gallons (GPT) to the clean fluid in the blender fluid flowline. The flow rate of the concentrated chemical may be adjusted. The methods described with respect to FIGS. 6 and 7 may also include providing a pressure dampener in the outlet flowline between the discharge of the pump and the first flow meter. The pressure dampener provides a continuous flow of the fluid exiting the pump so that pressure spikes or pulsations may be dampened to prevent damage to, for example, downstream measuring tools such as the first flow meter.

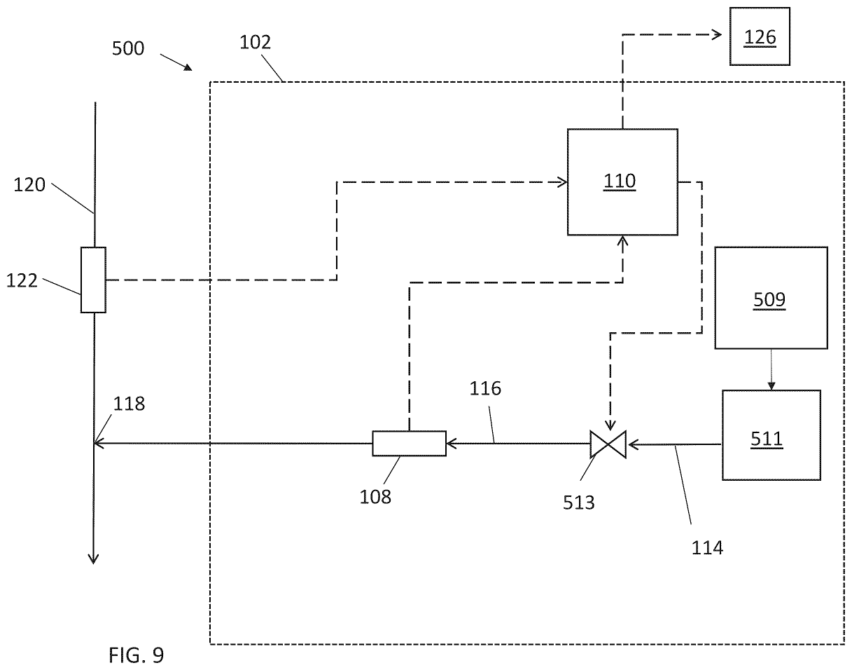

Referring now to FIG. 9, a schematic of a field delivery system 500 in accordance with embodiments of the present application is shown. The field delivery system 500 as shown in FIG. 9, provides pneumatically driven flow of a concentrated chemical (i.e., a frac additive) to a blender fluid flowline 120 in accordance with one or more embodiments. The field delivery system 500 may be provided in a module 102 or on a pallet (not shown) so that the system 500 is compact and easily transported, for example on the back of a small trailer, to a well site and may be movable via, for example, forklift or pallet jack. The field delivery system 500 provides a high concentration dosing system that includes a pressure vessel 511, a compressed air supply 509, a flow control valve 513, a flow meter 108, and a programmable logic controller (PLC) 110.

The pressure vessel 511 is connected between the compressed air supply 509 and the flow control valve 513. The pressure vessel 511 is connected to the flow control valve 513 via the inlet flowline 114. The pressure vessel 511 contains a volume of concentrated chemical (i.e., a frac additive). The pressure vessel 511 may be positioned in the module 102 or pallet or may be positioned next to the module 102 or pallet. A first end of the inlet flowline 114 may be coupled to a valve (not shown) on the pressure vessel 511 and a second end of the inlet flowline 114 may be coupled to an inlet of the flow control valve 513.

The compressed air supply 509 is configured to provide a pneumatically driven flow of the concentrated chemical in the pressure vessel 511 to the flow control valve 513. The flow control valve 513 is operatively connected to the PLC 110 such that the PLC 110 controls opening and closing of the flow control valve 513 to control the flow rate of the concentrated chemical through the flow control valve 513 into the blender fluid flowline 120. The flow control valve 513 may be any valve known in the art, for example, a gate valve, a globe valve, etc.

An outlet flowline 116 is coupled to an outlet of the flow control valve 513 and to an injection port or inlet 118 of a blender fluid flowline 120. The blender fluid flowline 120 may be a flowline external to the field delivery system 500 and therefore not housed within or on the module 102. A clean fluid is flowed through the blender fluid flowline 120 and includes one or more injection ports/inlets 118 through which one or more additives/chemicals are added to the clean fluid to form a blended fluid. The blender fluid flowline 120 may be a flowline that is coupled to an injection pump (not shown) for injecting the blended fluid (i.e., a combination of the clean fluid and one or more additives such as frac additives, including the concentrated chemical from the pressure vessel 511) into a formation for hydraulic fracturing of the formation rock.

The flow meter 108 may be disposed in the outlet flowline 116 and configured to measure a rate of flow of the concentrated chemical between the flow control valve 513 of the field delivery system 500 and the blender fluid flowline 120. In some embodiments, the flow meter 108 may be a turbine flow meter. In other embodiments, the flow meter 108 may be a Coriolis flow meter. The flow meter 108 may be operatively coupled to the PLC 110 and may transmit data representative of the flow rate of concentrated chemical in outlet flowline 116 to the PLC 110. The flow meter 108 may thus provide flow rate validation of the concentrated chemical exiting the flow control valve 513 to ensure that a proper dosing of the concentrated chemical is supplied to the blender fluid flowline 120.

The blender fluid flowline 120 also includes a flow meter 122 positioned upstream of the injection port or inlet 118 of the blender fluid flowline 120. Thus, the flow meter 122 is configured to measure the rate of flow of the clean fluid prior to the addition of the concentrated chemical from the field delivery system 100. As described above, the flow meter 122 may be, for example, a turbine flow meter or a Coriolis flow meter. The flow meter 122 of the blender fluid flowline 120 is operatively coupled to the PLC 110 of the field delivery system 500 and transmits data representative of the flow rate of the clean fluid in the blender fluid flowline 120 to the PLC 110. The PLC 110 may thus compare a first input (the flow rate of the concentrated chemical in outlet flowline 116) from the chemical flow meter 108 and a second input (the flow rate of the clean fluid in the blender fluid flowline 120 upstream of the injection port or inlet 118) from the blender flow meter 122 to validate the desired dosing of concentrated chemical to achieve a desired concentration in the blender fluid flowline 120.

In accordance with embodiments disclosed herein, the PLC 110 is configured to automatically adjust an opening of the flow control valve 513, and therefore adjust the dosing of concentrated chemical into the blender fluid flowline 120, in response to variations or changes in the flow rate of the clean fluid flowing through the blender fluid flowline 120, as measured by the flow meter 122. Further, PLC 110 may additionally or alternatively control a valve (not shown) in the blender fluid flowline 120 to adjust a flow rate of the clean fluid to ensure a desired and accurate dosing of the concentrated chemical is achieved. For example, the field delivery system 500 in accordance with embodiments disclosed herein provides concentrated chemicals (e.g., chemicals with activities of greater than 20%) at a loading of 0.010 to 0.15 GPT (0.010 to 0.15 l/m³) to the clean fluid in the blender fluid flowline 120.The field delivery system 500 may also include a human machine interface (HMI) 126, for example, a computer, tablet, monitor, etc. that allows the user to input data into and receive data from the PLC 110, as shown and discussed above with respect to FIG. 2. In one or more embodiments, the HMI 126 of the field delivery system 500 allows a user to input to the PLC 110 a set range of desired volumetric flow rates of the concentrated chemicals, concentrations of the concentrated chemicals, and/or ranges of desired concentrations of a blended flow of the concentrated chemicals combined with the clean fluid, and to receive data representative of, for example, the volumetric flow rate of concentrated chemicals in outlet flowline 116 and the volumetric flow rate of the clean fluid in blender fluid flowline 120. The PLC 110 may be coupled to one or more communication services such as a value-added network (VAN) or ethernet datalink 107 (FIG. 2).

Referring still to FIG. 9, in one or more embodiments, the field delivery system 500 may include more than flow control valve 513, flow meter 108, and additional flowlines (114, 116) to accommodate more than one concentrated chemical. For example, two pressure vessels 511 containing the same or different concentrated chemicals may be coupled to two separate inlet flowlines 114, with each inlet flowline 114 coupling each pressure vessel 511 to one or more flow control valves 513. Further, each flow control valve 513 may be coupled to the blender fluid flowline 120 via one or more outlet flowlines 116. Each flow control valve 513 is also coupled to the PLC 110 and configured to provide a desired dose of each concentrated chemical to the blender fluid flowline 120 through the outlet flowlines 116. Such configuration allows for two different chemicals at two same or different dosing rates to be provided to the same clean fluid in the blender fluid flowline 120 to obtain a desired makeup of a blended fluid. One of ordinary skill in the art will appreciate that two, three, or more pressure vessels 511 of different concentrated chemicals may similarly be coupled to the field delivery system 500, and thus the field delivery system 500 may include two, three, or more pressure vessels 511, PLCs 110, flow meters 108, and inlet and outlet flowlines 114, 116.

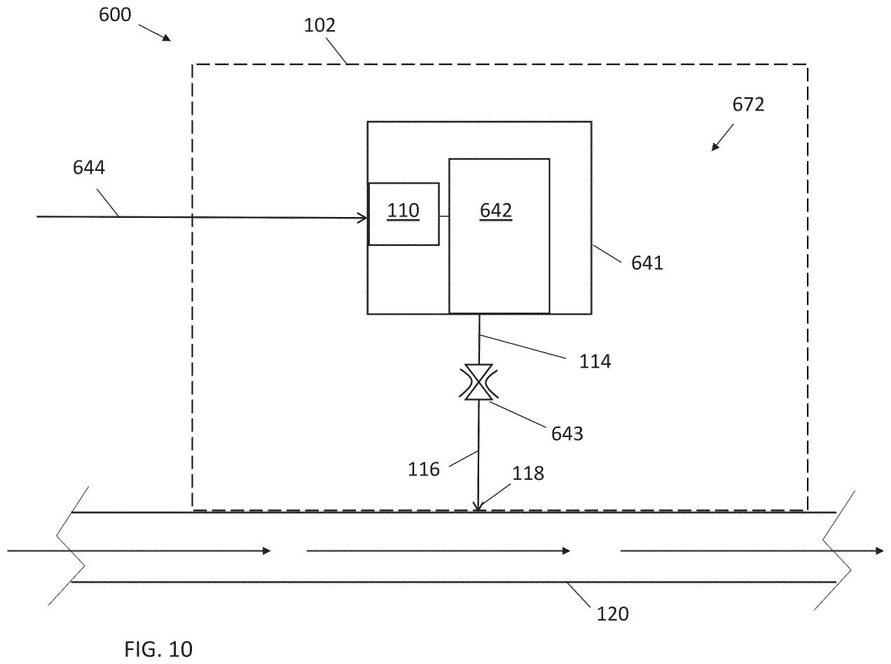

Referring now to FIG. 10, a field delivery system 600 is shown in accordance with embodiments of the present application. The field delivery system 600 as shown in FIG. 10, provides gravity fed restricted flow of a concentrated chemical (i.e., a frac additive) to a blender fluid flowline 120 in accordance with one or more embodiments. The field delivery system 600 may be provided in a module 102 or on a pallet (not shown) so that the system 600 is compact and easily transported, for example on the back of a small trailer, to a well site and may be movable via, for example, forklift or pallet jack. The field delivery system 600 includes a high concentration dosing system 672 that includes a valve 643 and a PLC 110. In one or more embodiments, the field delivery system 600 also includes an elevated structure 641.

The high concentration dosing system 672 may also include a container 642 connected to the valve 643 via an inlet flowline 114. The container 642 contains a volume of concentrated chemical (i.e., a frac additive). The container 642 may be a tote or other container configured to store concentrated chemical. The container 642 may include an opening (not shown) or valve (not shown) located on a bottom or lower surface of the container 642. A first end of the inlet flowline 114 may be coupled to the valve (not shown) on the container 642 and a second end of the inlet flowline 114 may be coupled to an inlet of the valve 643. The container 642 may be positioned in the module 102 or pallet or may be positioned next to the module 102 or pallet. In some embodiments, the container 642 is positioned on the elevated structure 641 to provide for flow of the concentrated chemical from the container 642 through the inlet flowline 114 and the valve 643 via gravity.

The field delivery system 600 is positioned above a fluid flow line, such as blender fluid flowline 120. An outlet flowline 116 is coupled to an outlet of the valve 643 and to an injection port or inlet 118 of the blender fluid flowline 120. The gravity fed field delivery system 600 may thus provide concentrated chemical from the module 102 to the bender fluid flowline 120 by operation of the valve 643.

The valve 643 may be a pinch valve or an iris valve. The valve 643 may be adjustable to providing an adjustable volumetric flow rate that corresponds to or matches a target loading rate based on a flow rate data input 644 to the PLC 110. The PLC 110 may be operatively coupled to the valve 643 and/or the valve (not shown) on the container 642. Although shown on the elevated structure, the PLC 110 may be located anywhere within the module 102. The valve 643 may be controlled to restrict a volumetric flow rate of concentrated chemical from the container 642 to the blender fluid flowline 120 to achieve a desired concentration downstream of an injection port/inlet 118 of the blender fluid flowline 120.

The blender fluid flowline 120 may be a flowline external to the field delivery system 600 and therefore not housed within or on the module 102. A clean fluid is flowed through the blender fluid flowline 120 and includes one or more injection ports/inlets 118 through which one or more additives/chemicals are added to the clean fluid to form a blended fluid. The blender fluid flowline 120 may be a flowline that is coupled to an injection pump (not shown) for injecting the blended fluid (i.e., a combination of the clean fluid and one or more additives such as frac additives, including the concentrated chemical from the container 642) into a formation for hydraulic fracturing of the formation rock.

In accordance with embodiments disclosed herein, the PLC 110 is configured to automatically adjust an opening of the valve 643, and therefore adjust the dosing of concentrated chemical into the blender fluid flowline 120, in response to a target loading rate based on customer flow rate data input 644 to the PLC 110. For example, the field delivery system 600 in accordance with embodiments disclosed herein provides concentrated chemicals (e.g., chemicals with activities of greater than 20%) at a loading of 0.010 to 0.15 GPT (0.010 to 0.15 l/m³) to the clean fluid in the blender fluid flowline 120. The field delivery system 600 may also include a human machine interface (HMI) 126, for example, a computer, tablet, monitor, etc. that allows the user to input data into and receive data from the PLC 110, as shown and discussed above with respect to FIG. 2. A person of ordinary skill in the art will appreciate that the field delivery system 600 may include more than one valve 564 for controlling a gravity fed flow of concentrated chemical to one or more injection ports/inlets 118 of the blended fluid flowline 120, without departing from the scope of embodiments described herein.

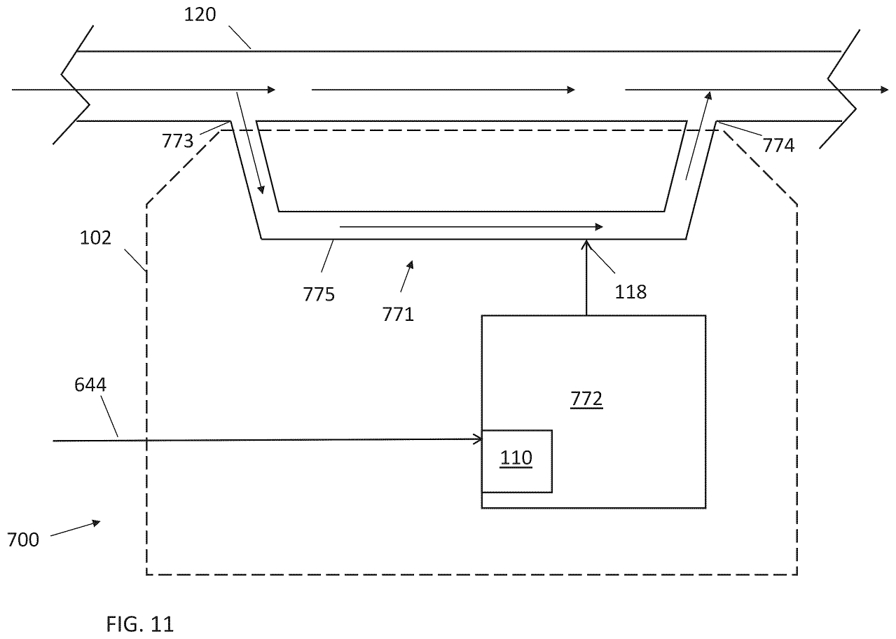

FIG. 11 shows a field delivery system 700 in accordance with embodiments of the present application. The field delivery system 700 shown in FIG. 11 is similar to the field delivery system 100 shown in FIG. 1 in that the field delivery system 700 may be provided in a module for delivery to a well site and include components of the field delivery system 100 discussed above and shown in FIG. 1; however, the field delivery system 700 is configured to provide a flow of concentrated chemical (i.e., a frac additive) to a slip stream instead of directly into a blender fluid flowline.

More specifically, the field delivery system 700 as shown in FIG. 11, provides a flow of a concentrated chemical to a slip stream 771 of a blender fluid flowline 120 in accordance with one or more embodiments. The field delivery system 700 may be provided in a module 102 or on a pallet (not shown) so that the system 700 is compact and easily transported, for example on the back of a small trailer, to a well site and may be movable via, for example, forklift or pallet jack. The field delivery system 700 includes a high concentration dosing system 772 with a PLC 110. The high concentration dosing system 772 may include one or more of the components provided in the module 102 of the field delivery system 100 discussed with respect to FIG. 1. For example, the high concentration dosing system 772 may include a pump 104, a variable frequency drive 106, a flow meter 108, and the PLC 110.

The high concentration dosing system 772 may also include a tote 112 for containing a volume of concentrated chemical (i.e., a frac additive) maybe connected to a suction end of the pump 104 via inlet flowline 114, as shown in FIG. 1. The tote may be positioned in the module 102 or pallet or may be positioned next to the module 102 or pallet of the field delivery system 700. A first end of the inlet flowline 114 may be coupled to a valve or tap (not shown) on the tote 112 and a second end of the inlet flowline 114 may be coupled to the suction end of the pump 104.

As described and shown with respect to field delivery system 100, the pump 104 in field delivery system 700 may be a positive displacement pump that is configured to provide a specific adjustable volumetric flowrate of a liquid, i.e., the concentrated chemical in the tote 112. The pump 104 may be a hydraulically driven diaphragm pump, a gear pump, or a peristaltic hose pump. The pump 104 includes a motor (not shown) which is controlled by a variable drive, such as the variable frequency drive 106 or variable speed drive. The variable frequency drive 106 is operatively connected to the PLC 110 and automatically controls the flow rate of the concentrated chemical through the pump 104 by changing the pump stroke speed of the pump 104. The pump 104 may include a calibrated dial for adjusting the capacity of the pump between, for example, 10% to 100%.

As shown in FIG. 11, the high concentration dosing system 772 of the field delivery system 700 is configured to inject a concentrated chemical into an injection port or inlet 118 of the slip stream 771. Specifically, an outlet flowline 116 is coupled to an outlet or discharge of the pump 104 (as shown in FIG. 1), and to an injection port or inlet 118 of the slip stream 771. The slip stream 771 may be a flowline 775 or pipe disposed within the module 102 and configured to connect between an outlet port 773 of the blender fluid flowline 120 and an inlet port 774 of the blender fluid flowline 120. The flowline 775 of the slip stream 771 is proportionally smaller than the blender fluid flowline 120. For example, the flowline 775 may have a diameter that is approximately 30 percent the value of the diameter of the blender fluid flowline 120. In some embodiments, the flowline 775 may have a diameter that is approximately 15, 20, or 40 percent the value of the diameter of the blender fluid flowline 120. One of ordinary skill in the art will appreciate that the diameter of the flowline 775 of the slip stream 771 may vary based on a particular application or may be selected based on a desired dosing of the concentrated chemical to the blender fluid flowline 120. In other embodiments, the diameter of the flowline 775 may be selected to be a size that is smaller than most standard blender fluid flowlines 120. At least a portion of the flowline 775 is positioned parallel to the blender fluid flowline 120. The flowline 775 may include portions that are non-parallel and non-perpendicular to the blender fluid flowline 120, those portions connecting the at least a portion of the flowline 775 that is parallel to the blender fluid flowline 120 to the outlet port 773 and inlet port 774 of the blender fluid flowline 120.

The high concentration dosing system 772 may also include flow meter 108 (as shown in FIG. 1) disposed in the outlet flowline 116 and configured to measure the rate of flow of the concentrated chemical between the pump 104 of the field delivery system 700 and the slip stream 771. In some embodiments, the flow meter 108 may be a turbine flow meter. In other embodiments, the flow meter 108 may be a Coriolis flow meter. The flow meter 108 may be operatively coupled to the PLC 110 and may transmit data representative of the flow rate of concentrated chemical in outlet flowline 116 to the PLC 110. The flow meter 108 may thus provide flow rate validation of the concentrated chemical exiting the pump 104 to ensure that a proper dosing of the concentrated chemical is supplied to the slip stream 771 and subsequently to the blender fluid flowline 120

The PLC 110 of the field delivery system 700 is operatively coupled to the high concentration dosing system 772. The dosing system 772 of the field delivery system 700 is configured to receive flow rate data input 644 to the PLC 110. Based on the flow rate data input received by the PLC 110, the high concentration dosing system 772 provides a dosing flow rate to the injection point or inlet 118 of the slip stream 771. For example, the dosing flow rate may be determined by the following equation, where V is the volumetric flow rate of the blender fluid flowline 120, X is the slip stream's 771 percentage of volumetric flow rate of the blender fluid flowline 120, and TLR is the target loading rate of high concentrated material:

$$Dosing Flow Rate = \frac{V}{X} * T L R \qquad Eq . 1$$

Thus, the dosing flow rate is provided so that when the slip stream 771 is reintroduced to the blender fluid flowline 120 at inlet port 774, the desired concentration in the blender fluid flowline 120 downstream of the field delivery system 700 is achieved. For example, the field delivery system 700 in accordance with embodiments disclosed herein provides concentrated chemicals (e.g., chemicals with activities of greater than 20%) at a loading of 0.010 to 0.15 GPT (0.010 to 0.15 l/m³) to the clean fluid in the blender fluid flowline 120.

The blender fluid flowline 120 may be a flowline external to the field delivery system 700 and therefore not housed within or on the module 102. A clean fluid is flowed through the blender fluid flowline 120 and includes one or more injection ports/inlets 118 through which one or more additives/chemicals are added to the clean fluid to form a blended fluid. The blender fluid flowline 120 may be a flowline that is coupled to an injection pump (not shown) for injecting the blended fluid (i.e., a combination of the clean fluid and one or more additives such as frac additives, including the concentrated chemical from the dosing system 772) into a formation for hydraulic fracturing of the formation rock.

In one or more embodiments, one or more flow meters (such as flow meter 122 shown in FIG. 1) may be positioned in the slip stream 771 or the blender fluid flowline 120 or one in both the slip stream 771 and the blender fluid flowline 120 upstream of the injection port or inlet 118 of slip stream 771. Thus, the flow meter(s) is configured to measure the rate of flow of the clean fluid prior to the addition of the concentrated chemical from the field delivery system 700. The flow meter may be, for example, a turbine flow meter or a Coriolis flow meter. The flow meter of the slip stream 771 and/or the blender fluid flowline 120 may be operatively coupled to the PLC 110 of the field delivery system 100 and may transmit data representative of the flow rate of the clean fluid in the slip stream 771 and/or the blender fluid flowline 120 to the PLC 110. The PLC 110 may thus compare a first input (the flow rate of the concentrated chemical in outlet flowline 116) and a second input (the flow rate of the clean fluid in the slip stream 771 and/or the blender fluid flowline 120 upstream of the injection port or inlet 118) to validate the desired dosing of concentrated chemical to achieve a desired concentration in the blender fluid flowline 120.

The field delivery system 700 may also include a human machine interface (HMI) 126, for example, a computer, tablet, monitor, etc. that allows the user to input data into and receive data from the PLC 110, as shown and discussed above with respect to FIGS. 1 and 2.

A method in accordance with embodiments disclosed herein may include providing a movable base with a high concentration dosing system, positioning the movable base at a worksite, coupling a flowline between the high concentration dosing system and a blender fluid flowline at the worksite, the blender fluid flowline providing a flow of a clean fluid, and providing a dosage of concentrated chemical of between 0.01 and 0.15 gallons per thousand gallons (GPT) to the clean fluid in the blender fluid flowline.

In one or more embodiments, the movable base may be provided with the high concentration system which includes a pump, a motor coupled to the pump, a variable drive coupled to the motor, a programmable logic controller coupled to the variable drive, an inlet flowline coupled to a suction end of the pump, an outlet flowline coupled to a discharge of the pump, and a first flow meter coupled to the outlet flowline. A flow rate of the concentrated chemical in the outlet flowline may be validated by measuring the flow rate of the concentrated chemical in the outlet flowline with the first flow meter, and providing the flow rate of the concentrated chemical as an input to the programmable logic controller. The flow rate of the concentrated chemical may be adjusted based on the validating of the flow rate of the concentrated chemical in the outlet flowline.

In one or more embodiments, the movable base may be provided with the high concentration system which includes a flow control valve, a programmable logic controller coupled to the flow control valve, a pressure vessel coupled to the flow control valve, an inlet flowline coupled between the pressure vessel and an inlet of the flow control valve, an outlet flowline coupled to an outlet of the flow control valve, and a first flow meter coupled to the outlet flowline. The concentrated chemical may be pneumatically transferred to the blender fluid flowline from the pressure vessel through inlet flowline, the flow control valve, the outlet flowline and the flow meter to the blender fluid flowline. In some embodiments, a flow rate of the concentrated chemical in the outlet flowline may be validated by measuring the flow rate of the concentrated chemical in the outlet flowline with the first flow meter, and providing the flow rate of the concentrated chemical as an input to the programmable logic controller. The flow rate of the concentrated chemical may be adjusted based on the validating the flow rate of the concentrated chemical in the outlet flowline.

In one or more embodiments, the movable base may be provided with the high concentration system which includes an elevated structure, a container disposed on the elevated structure, an inlet flowline coupled between the container and an inlet of the valve, and an outlet flowline coupled to an outlet of the valve. In some embodiments, flow rate data may be input into the programmable logic controller. The opening size (fully open to fully closed and positions therebetween) of the valve may be controlled by the programmable logic controller based on the flow rate data input. Control of the opening size of the valve also provides for transferring via gravity the concentrated chemical from the container through the inlet flowline, the valve, and the outlet flowline to the blender fluid flowline.

Embodiments disclosed herein may advantageously provide a method that includes providing a movable module to a worksite, the movable module including a pump, a variable frequency drive coupled to the pump, a programmable logic controller operatively coupled to the variable frequency drive, and a first flow meter coupled to an outlet of the pump. The method further includes coupling a tank to a suction end of the pump, the tank having a concentrated chemical disposed therein. In one example, the tank may be coupled to a suction end of the pump via an inlet flowline having a first end coupled to the tank and a second end coupled to the suction end of the pump. The method further includes coupling an outlet of the pump and to a blender fluid flowline, the blender fluid flowline positioned external to the movable the module. For example, a first end of an outlet flowline may be coupled to an outlet of the pump and a second end of the outlet flowline may be coupled to a blender fluid flowline. The method further includes providing a low dosage of the concentrated chemical of between 0.01 and 0.15 gallons per thousand gallons (GPT) to a clean fluid in the blender fluid flowline by pumping the concentrated chemical with the pump from the tank to the blender fluid flowline and adjusting an amount of the concentrated chemical pumped in response to data input into the programmable logic controller. The concentrated chemical may be pumped from the tank through the inlet flowline and the outlet flowline to the blender fluid flowline, and the amount of concentrated chemical pumped by the pump is in response to data input into the programmable logic controller. The adjusting may include controlling a flow rate of the concentrated chemical entering the blender fluid flowline which may include determining a flow rate of the concentrated chemical in an outlet flowline coupled between the outlet of the pump and the blender fluid flowline with the first flow meter, providing the flow rate as an input to the programmable logic controller, and providing a signal from the programmable logic controller to the variable frequency drive to adjust a motor coupled to the pump based on the flow rate of the concentrated chemical.

Embodiments disclosed herein may advantageously provide a system and method that allow for concentrated chemicals to be accurately provided to a clean water or blender fluid flowline at a very low dose. Because the concentrated chemicals can be accurately dosed into a blender fluid flowline, smaller volumes of chemicals will be needed at a wellsite. Therefore, costs associated with transportation of chemicals to a wellsite may be significantly reduced due to the reduction in volumetric storage requirements of the needed chemicals, logistical costs and traffic, and subsequent footprint of storage systems on the well pad. Instead of using multiple bulk trucks to transfer the liquid chemicals, a few totes of the concentrated chemicals can be delivered and the field delivery system described herein can be used to dose the appropriate low amount into the clean water flowline.

While the method and system have been described with respect to a limited number of embodiments, those skilled in the art, having benefit of this disclosure, will appreciate that other embodiments can be devised which do not depart from the scope as disclosed herein. Accordingly, the scope should be limited only by the attached claims.

What is claimed is:

1. A method comprising:
providing a movable module to a worksite, the movable module including a pump, a variable frequency drive coupled to the pump, a programmable logic controller operatively coupled to the variable frequency drive, and a first flow meter coupled to an outlet of the pump;
coupling a tank to a suction end of the pump, the tank having a concentrated chemical disposed therein;
coupling an outlet of the pump to a blender fluid flowline, the blender fluid flowline positioned external to the movable module; and
providing a low dosage of the concentrated chemical of between 0.01 and 0.15 gallons per thousand gallons (GPT) to a clean fluid in the blender fluid flowline by pumping the concentrated chemical with the pump from the tank to the blender fluid flowline and adjusting an amount of the concentrated chemical pumped in response to data input into the programmable logic controller.

2. The method of claim 1, wherein the adjusting the amount of the concentrated chemical comprises controlling a flow rate of the concentrated chemical entering the blender fluid flowline.

3. The method of claim 2, wherein controlling the flow rate of the concentrated chemical comprises:
determining a flow rate of the concentrated chemical in an outlet flowline coupled between the outlet of the pump and the blender fluid flowline with the first flow meter;
providing the flow rate as an input to the programmable logic controller; and
providing a signal from the programmable logic controller to the variable frequency drive to adjust a motor coupled to the pump based on the flow rate of the concentrated chemical.

4. The method of claim 3, wherein the providing the low dosage of concentrated chemical further comprises:
determining a flow rate of a clean fluid in the blender fluid flowline with a second flow meter coupled to the blender fluid flowline upstream of a coupling of a first end of the outlet flowline to the blender fluid flowline;
providing the flow rate as an input to the programmable logic controller; and
providing a signal from the programmable logic controller to the variable frequency drive to adjust the motor coupled to the pump based on the flow rate of the concentrated chemical and the flow rate of the clean fluid.

5. The method of claim 1, wherein the coupling the tank to the suction end of the pump comprises coupling a valve of a tote to an inlet flowline coupled to the suction end of the pump.

6. The method of claim 1, further comprising:
providing the movable module with a second pump, a second variable frequency drive coupled to the second pump, the second variable frequency drive coupled to the programmable logic controller, and a third flow meter coupled to an outlet of the second pump;
coupling a second tank to a suction end of the second pump, the second tank having a second concentrated chemical disposed therein;
coupling an outlet of the second pump to the blender fluid flowline; and
providing a low dosage of the second concentrated chemical of between 0.01 and 0.15 gallons per thousand gallons (GPT) to the clean fluid in the blender fluid flowline by pumping the second concentrated chemical with the second pump from the second tank to the blender fluid flowline and adjusting an amount of the second concentrated chemical pumped in response to data input into the programmable logic controller.

7. The method of claim 1, wherein the concentrated chemical is one of a biocide, a surfactant, a scale inhibitor, or a clay stabilizer.

8. The method of claim 1, wherein the concentrated chemical is a frac additive with an activity of greater than 30%.

9. The method of claim 1, wherein the concentrated chemical is a frac additive with an activity of greater than 20%.

10. The method of claim 1, wherein the data input into the programmable logic controller includes at least one of a flow rate of the concentrated chemical exiting the outlet of the pump or a flow rate of the clean fluid in the blender fluid flowline.

11. A method comprising:
providing a movable base with a high concentration dosing system;
positioning the movable base at a worksite, coupling a flowline between the high concentration dosing system and a blender fluid flowline at the worksite, the blender fluid flowline providing a flow of a clean fluid; and
providing a dosage of concentrated chemical of between 0.01 and 0.15 gallons per thousand gallons (GPT) to the clean fluid in the blender fluid flowline.

12. The method of claim 11, wherein the providing the movable base with the high concentration dosing system comprises providing the movable base with a pump, a motor coupled to the pump, a variable drive coupled to the motor, a programmable logic controller coupled to the variable drive, an inlet flowline coupled to a suction end of the pump, an outlet flowline coupled to a discharge of the pump, and a first flow meter coupled to the outlet flowline, the method further comprising:
validating a flow rate of the concentrated chemical in the outlet flowline, the validating comprising measuring the flow rate of the concentrated chemical in the outlet flowline with the first flow meter, and providing the flow rate of the concentrated chemical as an input to the programmable logic controller; and
adjusting the flow rate of the concentrated chemical based on the validating the flow rate of the concentrated chemical in the outlet flowline.

13. The method of claim 12, wherein the adjusting the flow rate of the concentrated chemical comprises sending a signal from the programmable logic controller to the variable drive to vary a frequency and voltage input to the motor and control the pump to maintain the dosage of concentrated chemical of between 0.01 and 0.15 gallons per thousand gallons (GPT) to the clean fluid in the blender fluid flowline.

14. The method of claim 12, wherein the adjusting the flow rate of the concentrated chemical further comprises:
measuring a flow rate of the clean fluid in the blender fluid flowline with a second flow meter coupled to the blender fluid flowline;
providing the flow rate of the clean fluid as an input to the programmable logic controller; and
sending a signal from the programmable logic controller to the variable drive based on the flow rate of the concentrated chemical and the flow rate of the clean fluid to vary a frequency and a voltage input to the motor to control the pump.

15. The method of claim 11, wherein the providing the movable base with the high concentration system comprises providing the movable base with a flow control valve, a programmable logic controller coupled to the flow control valve, a pressure vessel coupled to the flow control valve, an inlet flowline coupled between the pressure vessel and an inlet of the flow control valve, an outlet flowline coupled to an outlet of the flow control valve, and a first flow meter coupled to the outlet flowline, the method further comprising:
pneumatically transferring the concentrated chemical to the blender fluid flowline from the pressure vessel through inlet flowline, the flow control valve, the outlet flowline and the flow meter to the blender fluid flowline;
validating a flow rate of the concentrated chemical in the outlet flowline, the validating comprising measuring the flow rate of the concentrated chemical in the outlet flowline with the first flow meter, and providing the flow rate of the concentrated chemical as an input to the programmable logic controller; and
adjusting the flow rate of the concentrated chemical based on the validating the flow rate of the concentrated chemical in the outlet flowline.

16. The method of claim 11, wherein the providing the movable base with the high concentration system comprises providing the movable base with an elevated structure, a container disposed on the elevated structure, an inlet flowline coupled between the container and an inlet of a valve, and an outlet flowline coupled to an outlet of the valve, the method further comprising:
inputting flow rate data to a programmable logic controller;
controlling an opening size of the valve; and
transferring via gravity the concentrated chemical from the container through the inlet flowline, the valve, and the outlet flowline to the blender fluid flowline.

17. The method of claim 11, wherein the providing the dosage of concentrated chemical of between 0.01 and 0.15 gallons per thousand gallons (GPT) to the clean fluid in the blender fluid flowline comprises:
inputting flow rate data into a programmable logic controller operatively coupled to the high concentration dosing system;
injecting a concentrated chemical based on the inputting into a slip stream provided on the movable base and coupled between an outlet port of the blender fluid flowline and an inlet of the blender fluid flowline; and
reintroducing the slip stream with the concentrated chemical into the blender fluid flowline through the inlet port.

18. A system comprising:
a pump;
a variable drive coupled to the pump;
a flow meter coupled to an outlet of the pump;
a programmable logic controller operatively coupled to the flow meter and operatively coupled to the variable drive;
a base, wherein the pump, the variable drive, the flow meter, and programmable logic controller are coupled to the base; and
an inlet flowline coupled to a suction end of the pump and an outlet flowline coupled to a discharge end of the pump,
wherein the programmable logic controller is configured to receive from the flow meter data representative of a flow rate of a concentrated chemical discharged by the pump and to send a signal to the variable drive to control the pump based on the data representative of the flow rate of the concentrated chemical to provide a dosage of the concentrated chemical of between 0.01 and 0.15 gallons per thousand gallons (GPT) to a clean fluid.

19. The system of claim 18, further comprising a pressure dampener coupled to the outlet flowline between the discharge end of the pump and the flow meter.

20. The system of claim 18, further comprising a blender fluid flowline, the outlet flowline coupled to the blender fluid flowline, and a second flow meter coupled to the blender fluid flowline upstream of the outlet flowline, the second flow meter operatively coupled to the programmable logic controller.
